(19) United States
(12) Patent Application Publication
(10) Pub. No.: US 2023/0329193 A1
(43) Pub. Date: Oct. 19, 2023

(54) STICK FLICK ANIMAL TOY

(71) Applicant: David Mulford, Woodbridge, NJ (US)

(72) Inventor: David Mulford, Woodbridge, NJ (US)

(21) Appl. No.: 17/722,463

(22) Filed: Apr. 18, 2022

(51) Int. Cl. A01K 15/02

(52) U.S. Cl. CPC A01K 15/025

(57) ABSTRACT

An animal toy for use with an animal, such as a canine, is described. The animal toy includes a body portion. The body portion includes a first side disposed opposite a second side and an opening disposed in a center of the body portion. The first side of the body portion of the animal toy includes a planar portion disposed circumferentially around the opening, a sidewall located on a circumference of the planar portion and extending away from the opening, and a ridge component affixed to the sidewall. The second side of the body portion of the animal toy includes a concave portion affixed to the sidewall. An object may contact an interior of the concave portion such that a user can perform an action to throw the animal toy to a new location.

### FIELD OF THE EMBODIMENTS

This invention relates to animal toys, and more specifically, to a disk-shaped flying toy for interactive play between a person and an animal.

### BACKGROUND OF THE EMBODIMENTS

Disk-shaped or saucer-shaped flying toys are commonly used for interactive play between people and domesticated pets, such as dogs. The flying toy is tossed with backspin into the air by the person and as it hovers in the air, the dog will usually chase it and try to catch the toy in its mouth and may then retrieve it. However, these toys are often difficult for people to throw long distances and are often difficult to throw for individuals having physical disabilities. To address these aforementioned problems, some groups have developed manual or automatic toy ball launchers. However, these devices are limited to throwing a dog ball and cannot be used with other dog toys. The present invention addresses these concerns and provides a novel animal toy.

### SUMMARY OF THE EMBODIMENTS

The present invention and its embodiments relate to animal toys, and more specifically, to a disk-shaped flying toy for interactive play between a person and an animal.

An embodiment of the present invention describes an animal toy for use with an animal (e.g., a “StickFlick” animal toy). In preferred examples, the animal is a domesticated animal, such as a canine. In general, the animal toy comprises a body portion. The body portion of the animal toy includes a first side disposed opposite a second side and an opening disposed in a center of the body portion.

The first side of the body portion of the animal to includes a planar portion disposed circumferentially around the opening and a sidewall located on a circumference of the planar portion and extending away from the opening. The first side of the body portion of the animal toy also includes a ridge component affixed to the sidewall. In examples, the planar portion comprises a donut-shape. Further, the opening and the planar portion are located in a same plane. The second side of the body portion of the animal includes a concave portion affixed to the sidewall.

An object, such as a stick or a rod, is configured to contact an interior of the concave portion such that a user can perform an action to throw the animal toy to a new location. The action may be an upward flicking action, a sideways flicking action, and/or a throwing action, among other actions not explicitly listed herein.

In other examples, at least one of an interior of the sidewall and an interior of the concave portion include one or more protrusions extending away from the sidewall or the concave portion in a direction towards the opening. A shape of the one or more protrusions may be a circular shape, an oval shape, a rectangular shape, a square shape, a triangular shape, a quadrilateral shape, a pentagonal shape, a hexagonal shape, a heptagonal shape, an octagonal shape, a nonagonal shape, or a decagonal shape, among other shapes not explicitly listed herein.

In another example, a first subset of the one or more protrusions includes a first shape and a second subset of the one or more protrusions includes a second shape, where the first shape differs from the second shape. In a first example, each protrusion of the one or more protrusions are spaced equidistant from one another. In a second example, each protrusion of the one or more protrusions are not spaced equidistant from one another.

In these examples, the object (e.g., the stick or the rod) is configured to contact at least one protrusion of the one or more protrusions of the interior of the sidewall or the interior of the concave portion such that the user can perform the action to throw the animal toy to a new location, as described herein.

### BRIEF DESCRIPTION OF THE DRAWINGS

FIG. 1 depicts a schematic diagram of a first side of an animal toy, according to at least some embodiments disclosed herein.

FIG. 2 depicts a schematic diagram of a second side of an animal toy, according to at least some embodiments disclosed herein.

FIG. 3 depicts a schematic diagram of a top down view of an animal toy, according to at least some embodiments disclosed herein.

FIG. 4 depicts a schematic diagram of a second side of an animal toy, showcasing specific dimensions of various components, according to at least some embodiments disclosed herein.

FIG. 5 depicts a schematic diagram of a user interacting with an object, which contacts an animal toy during use, according to at least some embodiments disclosed herein.

FIG. 6 depicts another schematic diagram of a user interacting with an object, which contacts an animal toy during use, according to at least some embodiments disclosed herein.

FIG. 7 depicts another schematic diagram of a user interacting with an object, which contacts an animal toy during use, according to at least some embodiments disclosed herein.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As used herein, the singular forms “a,” “an,” and “the,” are intended to include the plural forms as well, unless the context clearly indicates otherwise.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, an “embodiment” means that a particular feature, structure or characteristic is included in at least one or more manifestations, examples, or implementations of this invention. Furthermore, the particular features, structures or characteristics may be combined in any suitable manner, as would be apparent to a person skilled in the art. Combinations of features of different embodiments are ail meant to be within the scope of the invention, without the need for explicitly describing every possible permutation by example. Thus, any of the claimed embodiments can be used in any combination.

The phrase “and/or,” as used herein in the specification and in the claims, should be understood to mean “either or both” of the elements so conjoined, e.g., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

When the term “about” is used in conjunction with a numerical range, it modifies that range by extending the boundaries above and below those numerical values. In general, the term “about” is used herein to modify a numerical value above and below the stated value by a variance of 20%, 10%, 5%, or 1%. In certain embodiments, the term “about” is used to modify a numerical value above and below the stated value by a variance of 10%. In certain embodiments, the term “about” is used to modify a numerical value above and below the stated value by a variance of 5%. In certain embodiments, the term “about” is used to modify a numerical value above and below the stated value by a variance of 1%.

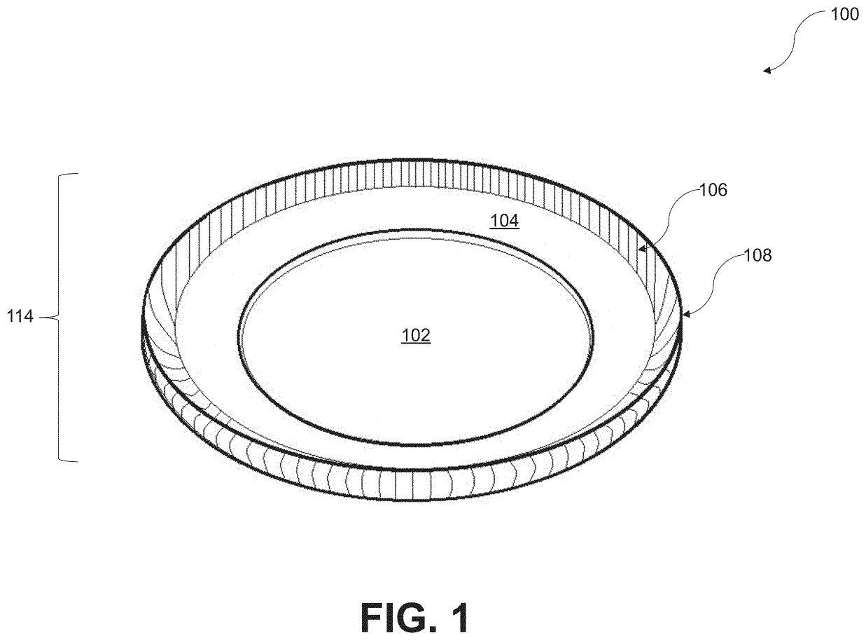

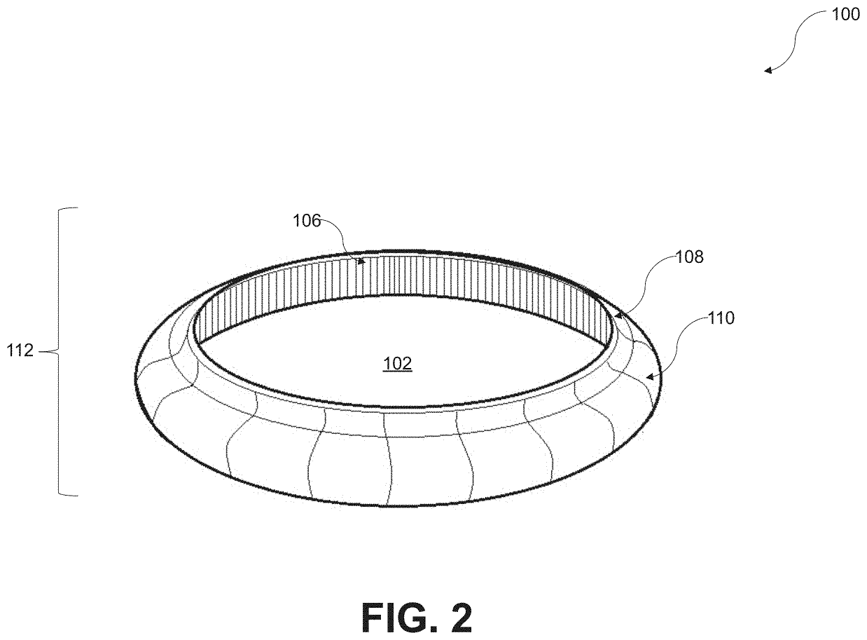

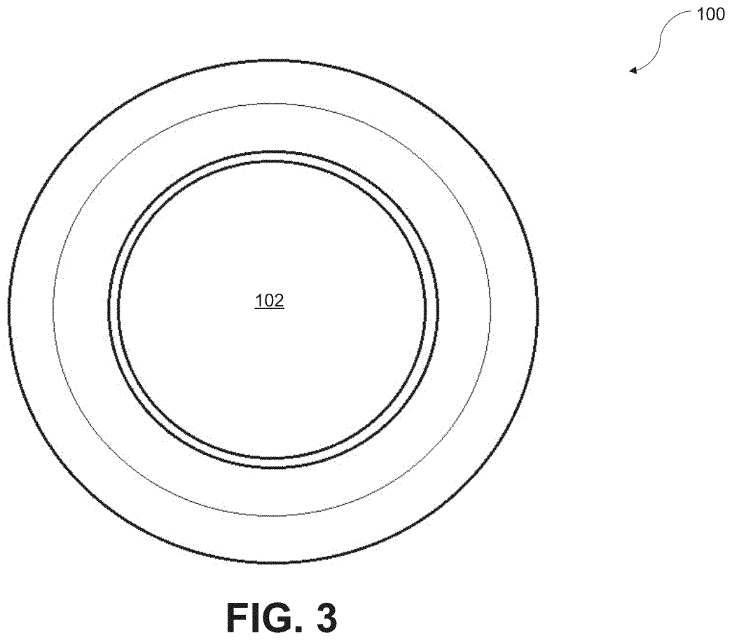

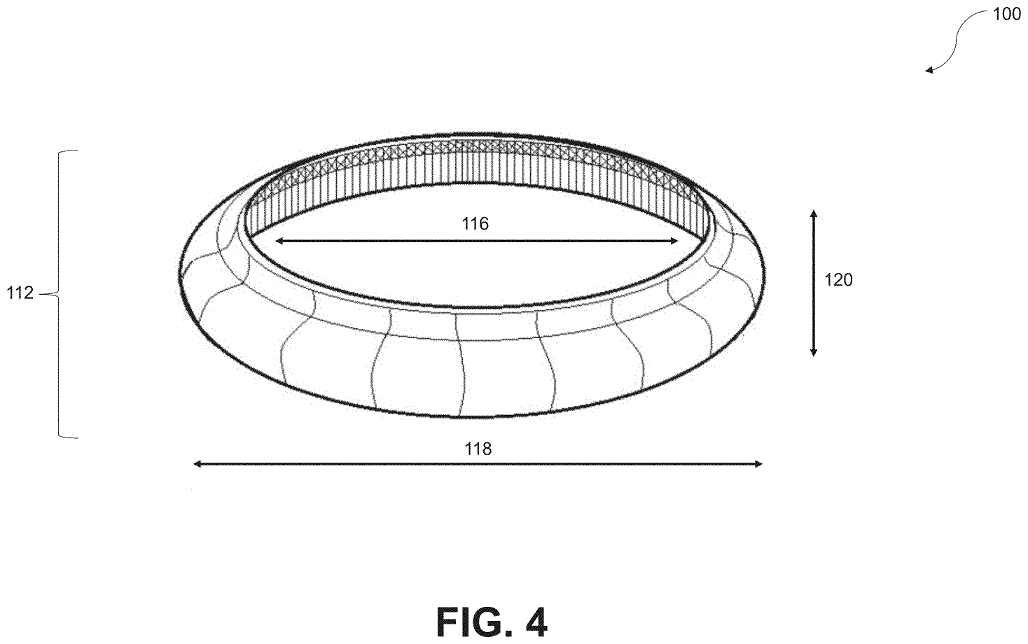

An animal toy 100 for use with an animal (e.g., a “StickFlick” toy) is described herein. In preferred examples, the animal is a domesticated animal, such as a canine. However, the animal is not limited to such. In general, the animal toy 100 comprises a body portion. The body portion of the animal toy 100 includes a first side 114 (of FIG. 1) disposed opposite a second side 112 (of FIG. 2 and FIG. 4) and an opening 102 disposed in a center of the body portion. A top down view of the animal toy 100 is shown in FIG. 3.

As shown in FIG. 1, the first side 114 of the body portion of the animal toy 100 includes a planar portion 104 disposed circumferentially around the opening 102 and a sidewall 106 located on a circumference of the planar portion 104 and extending away from the opening 102. A ridge component 108 is affixed to the sidewall 106 on a side opposing the planar portion 104.

In examples, the planar portion 104 comprises a donut-shape. Further, the opening 102 and the planar portion 104 are located in a same plane. As shown in FIG. 2 and FIG. 4, the second side 112 of the body portion of the animal toy 100 includes a concave portion 110 affixed to the sidewall 106.

In general, and as shown in FIG. 4, a diameter of the opening 102 (e.g., a dimension 116) is about 6 inches, a diameter of the animal toy 100 (e.g., a dimension 118) is about 9 inches, and a height of the animal toy 100 (e.g., a dimension 120) is about 1 inch. Further, one or more portions of the animal toy 100 may comprise a non-toxic natural rubber and/or plastic material. However, it should be appreciated that these dimensions and the materials are being provided for illustrative purposes only and other dimensions and materials not explicitly listed herein are contemplated by Applicant.

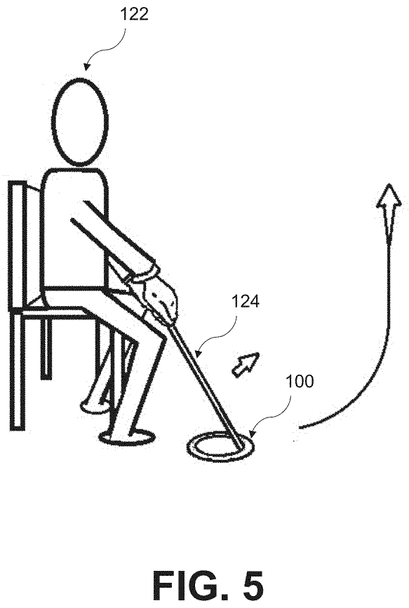

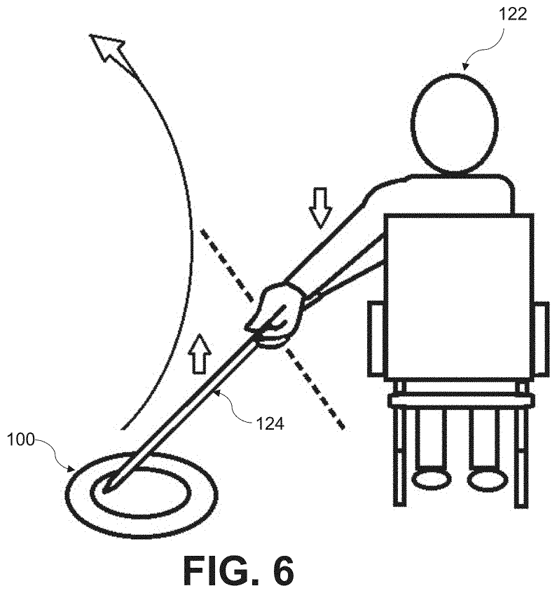

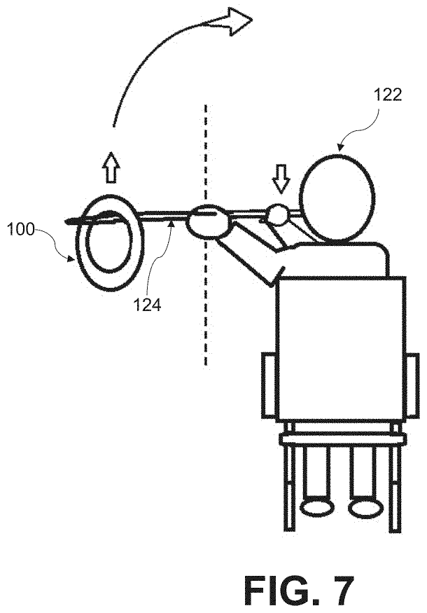

As shown in FIG. 5, FIG. 6, and FIG. 7, an object 124, such as a stick or a rod, is configured to contact an interior of the concave portion 110 such that a user 122 can perform an action to throw the animal toy 100 to a new location. The action may be an upward flicking action, a sideways flicking action, and/or a throwing action, among other actions not explicitly listed herein.

In other examples, at least one of an interior of the side-wall 106 and an interior of the concave portion 110 comprises one or more protrusions extending away from the interior of the sidewall 106 or the interior of the concave portion 110 in a direction towards the opening 102. A shape of the one or more protrusions may be a circular shape, an oval shape, a rectangular shape, a square shape, a triangular shape, a quadrilateral shape, a pentagonal shape, a hexagonal shape, a heptagonal shape, an octagonal shape, a nonagonal shape, or a decagonal shape, among other shapes not explicitly listed herein.

In another example, a first subset of the one or more protrusions includes a first shape and a second subset of the one or more protrusions includes a second shape, where the first shape differs from the second shape. In a first example, each protrusion of the one or more protrusions are spaced equidistant from one another. In a second example, each protrusion of the one or more protrusions are not spaced equidistant from one another.

In these examples, the object 124 is configured to contact at least one protrusion of the one or more protrusions of the interior of the sidewall 106 or the interior of the concave portion 110 such that the user 122 can perform the action to throw the animal toy 100 to a new location, as described herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. An animal toy for use with an animal, the animal toy comprising:
a body portion comprising:
a first side disposed opposite a second side; and
an opening disposed in a center of the body portion;
the first side comprising:
a planar portion disposed circumferentially around the opening;
a sidewall located on a circumference of the planar portion and extending away from the opening; and
a ridge component affixed to the sidewall; and
the second side comprising a concave portion affixed to the sidewall.

2. The animal toy of claim 1, wherein the planar portion comprises a donut-shape.

3. The animal toy of claim 1, wherein the animal is a domesticated animal.

4. The animal toy of claim 3, wherein the animal is a canine.

5. The animal toy of claim 1, wherein the opening and the planar portion are located in a same plane.

6. The animal toy of claim 1, wherein an object is configured to contact an interior of the concave portion such that a user can perform an action to throw the animal toy to a new location.

7. The animal toy of claim 6, wherein the object is a stick or a rod.

8. The animal toy of claim 6, wherein the action is selected from the group consisting of: an upward flicking action, a sideways flicking action, and a throwing action.

9. The animal toy of claim 1, wherein at least one of an interior of the sidewall and an interior of the concave portion comprise one or more protrusions extending away from the interior of the sidewall or away from the interior of the concave portion in a direction towards the opening.

10. The animal toy of claim 9, wherein each protrusion of the one or more protrusions are spaced equidistant from one another.

11. The animal toy of claim 9, wherein each protrusion of the one or more protrusions are not spaced equidistant from one another.

12. The animal toy of claim 9, wherein a shape of the one or more protrusions are selected from the group consisting of: a circular shape, an oval shape, a rectangular shape, a square shape, a triangular shape, a quadrilateral shape, a pentagonal shape, a hexagonal shape, a heptagonal shape, an octagonal shape, a nonagonal shape, and a decagonal shape.

13. The animal toy of claim 9,
wherein a first subset of the one or more protrusions comprise a first shape, and
wherein a second subset of the one or more protrusions comprise a second shape.

14. The animal toy of claim 13, wherein the first shape differs from the second shape.

15. The animal toy of claim 9, wherein an object is configured to contact at least one protrusion of the one or more protrusions of the interior of the sidewall or the interior of the concave portion such that a user can perform an action to throw the animal toy to a new location.

16. The animal toy of claim 15, wherein the object is a stick or a rod.

17. The animal toy of claim 15, wherein the action is selected from the group consisting of: an upward flicking action, a sideways flicking action, and a throwing action.

18. The animal toy of claim 1, wherein a diameter of the opening is about 6 inches.

19. The animal toy of claim 1, wherein a diameter of the animal toy is about 9 inches.

20. The animal toy of claim 1, wherein a height of the animal toy is about 1 inch.
